(19) United States
(12) Patent Application Publication
(10) Pub. No.: US 2005/0139756 A1
(43) Pub. Date: Jun. 30, 2005

(54) Emissive indicator device

(75) Inventors: Cheryl J. Brickey, Webster, NY (US); Robert P. Bourdelais, Pittsford, NY (US); Wen-Li A. Chen, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/747,605

(22) Filed: Dec. 29, 2003

(51) Int. Cl. G01D 5/34

(52) U.S. Cl. 250/231.1

(57) ABSTRACT

The invention relates to a timing device comprising an indicator device and a detector wherein said indicator device comprises a light-emissive element and a patterning layer.

### FIELD OF THE INVENTION

This invention relates to the formation of a timing device comprising an indicator device and a detector where the indicator device comprises a light-emissive element and a patterning layer.

### BACKGROUND OF THE INVENTION

Timing devices allow devices such as ink jet print heads to be accurately positioned in space. In general, timing control elements are either rotatable about a central axis, i.e., timing disk, or are movable in a linear direction, i.e., timing rule. Light, projected by a transmitter, passes through the control element, and is intercepted by the receiver. The receiver, responsive to the light, converts the light into an electrical signal capable of controlling machinery and other servo-mechanical devices.

Indicator devices typically are encoded with a selected window pattern, i.e., they have an annular or linear array of windows that alternate in a transparent window, opaque window, transparent window, and opaque window pattern. While the transparent window openings allow the transmitted light to pass through the indicator disk or rule, the opaque windows prevent the light from passing through the timing disk or rule.

Timing disks as a rule are fixed to a rotating shaft by means of a hub. For linear systems, timing rules are arranged at right angles to a source of light and the associated receiver generates an electrical signal in response to the incoming light. This particular application is used, for example, to control the feeding action of machine tools.

As the timing disk rotates or the timing rule moves in a linear direction, light is directed at the selected window pattern. Because of the window pattern, the transmitted light can only pass through a transparent window. In response to the light, the receiver generates an electrical signal.

The electrical signals serve to establish a control surface for the measurement of rotational speed, acceleration and more accurate positioning of servomechanical elements, as for example a printing head, a robot arm or a tool carrier.

Timing control elements can be made of glass, metal or plastic, however, plastic and metal are typically used in mass production applications. They are produced, for example, in the case of angle indicators or encoding units, e.g. ink jet printers, out of transparent films.

Timing control elements are generally constructed of light-sensitive film. Coding of the film occurs when the film is exposed to light passed through a template means. The coding results in the production of an alternating pattern of transparent and opaque windows. Individual disks or rules are then cut out of the film material to generate timing disks or timing rules, respectively.

Known timing devices utilize an arrangement whereby the transmitter is placed on one side of the timing structure and the receiver is placed on the other side of the timing structure to capture the light as it passes through the disk. This arrangement has been known to cause a number of problems, including: a requirement for a complex electromechanical apparatus, increased mechanical stress caused by oscillating loads, a larger footprint size for the timing device, and dirt forming on the timing structure, thereby preventing light from passing efficiently through the structure.

U.S. Pat. No. 4,387,374 (Wiener) discloses a timing device in which the indicator device is an operator rotatable cylindrically shaped encoder wheel with longitudinal slits. LED's are used as the light source on the outside of the cylinder and the detector is on the inside of the cylinder and receives light as the cylinder spins and lets light into the center of the cylinder through the slits. While this arrangement allows the timing device to be made smaller, it would be beneficial to eliminate a separate light source and incorporate it into the cylinder layer.

U.S. Pat. No. 4,953,933 (Asmar) discloses the use of optical fibers or light guides that function as a read-head for such optical position encoders delivering light to a detector to form a timing device. Although decoupling the light source from the detector saves space and allows the timing devices to be used in different applications, the optical fibers placement would be have to be extremely precise in order to deliver a clear signal to the detector resulting in a very complex and expensive timing device.

U.S. Pat. No. 6,201,239 (Yamamoto et al.) discloses an optical encoder that has a surface emitting semiconductor laser as a light source, a movable scale, and a detector. The object of the invention was to provide an optical encoder using a surface emitting laser, wherein when the light source and the scale (patterned) are situated relatively close to each other, such that the scale pitch can be made less than that in a conventional optical encoder. While this reduces the size of the timing device enabling the movable patterned scale and the light source to be close in proximity, the light source and the patterning layer are two separate layers thereby not reducing the complexity of the timing device. It would be beneficial to be able to combine the light source and the patterning layer, making the indicator device capable of more flexible setup positions for a variety of different applications and be smaller.

### PROBLEM TO BE SOLVED BY THE INVENTION

There remains a need for an indicator device that emits light so that the timing device can eliminate a separate light source and reduce the amount of electricity used.

### SUMMARY OF THE INVENTION

It is an object of the invention to provide a timing device with a light-emitting indicator device.

It is another object to provide a timing device that has several operational modalities.

It is a further object to provide a timing device that can be made smaller in size.

These and other objects of the invention are accomplished by a timing device comprising an indicator device and a detector wherein said indicator device comprises a light-emissive element and a patterning layer.

### ADVANTAGEOUS EFFECT OF THE INVENTION

The invention provides an indicator device that emits light so that the timing device can be made smaller. Further, the invention provides light-emissive elements that reduce the amount of electricity used.

### BRIEF DESCRIPTION OF THE DRAWINGS

FIG. 1 shows an indicator element with a light emissive element and a patterning layer.

FIG. 2 shows an indicator element with an electroluminescent light emissive element and a patterning layer.

FIG. 3 shows an indicator element with a light emissive element, a patterning layer, and light shaping elements.

FIG. 4 shows an indicator element with an electroluminescent light emissive element with a transparent rear electrode and two patterning layers, one on each side of the light emissive element.

FIG. 5 shows an indicator element with an electroluminescent light emissive element with a patterned transparent conductive layer.

### DETAILED DESCRIPTION OF THE INVENTION

The invention has numerous advantages compared to prior art timing devices. Because the indicator device combines the light source (the light emissive element) and the pattering layer), the timing device takes up less space and can therefore be used in some applications where a prior art timing device would not fit. Furthermore, combining the light source and the patterning layer simplifies the system making it more robust and simpler. The light emissive elements suggested typically consume less power and generate less heat than the prior art lasers and other light sources.

Operation modalities are defined as any operational mode of the timing device that changes the way the timing device is operated. The timing device of the invention can be operated in several different operational modalities, allowing making the timing device very versatile. Some of the operation modalities that the invention can function in are on/off pulses, using color or multiple colors, changing frequency in pulses, or can be pixilated. For example, the light-emissive element can operate such that it pulses on and off and these pulses can be timed with the detection device detecting. The pixelation can come from the patterning layer being a conductive material such that the light-emissive element only emits in pixels that are turned on so that the patterning layer and the indicator device can have a changeable pattern. This would be well suited to a device that changed the scale it was run at or for a timing device that could be moved to different applications as needed. The pixel pattern could be changed each time to create a specific pattern for each timing application. The light-emissive elements used have an increased color gamut. These and other advantages will be apparent from the detailed description below.

The term as used herein, “transparent” means the ability to pass radiation without significant deviation or absorption. For this invention, “transparent” material is defined as a material that has a spectral transmission greater than 90%. For a photographic element, spectral transmission is the ratio of the transmitted power to the incident power and is expressed as a percentage as follows: T_{RGB}=10^{-D}*100 where D is the average of the red, green and blue Status A transmission density response of the processed minimum density of the photographic element as measured by an X-Rite model 310 (or comparable) photographic transmission densitometer.

The term “light” means visible light. The term “diffuse light transmission,” means the percent diffusely transmitted light at 500 nm as compared to the total amount of light at 500 nm of the light source. The term “total light transmission” means percentage light transmitted through the sample at 500 nm as compared to the total amount of light at 500 nm of the light source. This includes both spectral and diffuse transmission of light. The term “diffuse light transmission efficiency” means the ratio of % diffuse transmitted light at 500 nm to % total transmitted light at 500 nm multiplied by a factor of 100. The term “polymeric film” means a film comprising polymers. The term “polymer” means homo- and co-polymers.

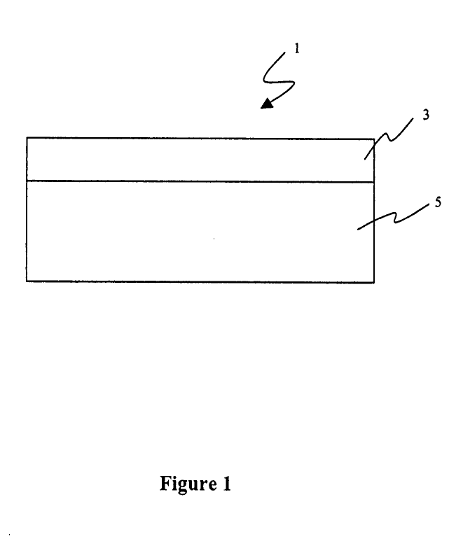

FIG. 1 illustrates a cross section of the indicator element 1 of the invention. A patterning layer 3 is on a light emissive element 5.

The light emissive element can be any element that emits light, preferably a thin element such that the emissive element can be placed into devices. Some examples of light emitting elements are electroluminescent elements, OLEDs, phosphorescent materials, fluorescent, chemiluminescent and many others.

Preferably, the emissive element comprises electroluminescent material because electroluminescent materials typically have low power consumption, wide range of emitting colors, easily processed, and relatively inexpensive. The electroluminescent material can be of the laminate type or dispersion type. A typical electroluminescent member is made up of a front electrode, a light-emitter layer, an insulating layer, and a back electrode.

A preferred example of a suitable a light-emitting electroluminescent (EL) material is zinc sulfide doped with copper or manganese. Those skilled in the art will be able to readily select suitable electroluminescent material, taking into consideration factors such as conditions of humidity, temperature, sun exposure, etc. in which the final article will be used, desired color of light emission, available power sources, etc.

The particles of light-emitting electroluminescent material may be coated, e.g., with a transparent oxide film, to improve the durability and resistance to humidity thereof. For example, U.S. Pat. No. 5,156,885 (Budd) discloses encapsulated phosphors that would be useful in articles of the invention.

The EL material may be selected to emit the desired color, e.g., white, red, blue, green, blue-green, orange, etc. Two or more different EL materials may be used in combination to generate the desired color. The materials may be dispersed throughout a single layer, or two or more layers may be overlaid upon one another.

The amount of electroluminescent material in the light-emissive element is dependent in part upon the brightness of emission that is desired and inherent brightness of the EL material. Typically the layer will contain between about 50 and about 200 parts by weight of EL material per 100 parts by weight of the matrix resin.

The insulating layer is typically made of a polymeric material having a high dielectric constant, e.g., cyanoethylcellulose or fluororesins in which a pigment (e.g., PbTiO₃, BaTiO₃, SrTiO₃, Y₂O₃, TiO₂, SiO₂, Al₂O₃, etc.) having a high dielectric constant is uniformly dispersed.

The pigment loading in the insulating layer is typically preferably between about 30 and about 100 parts by weight per 100 parts by weight of resin. If the loading is too low, resultant insulation properties may be too low. If the loading is too high, it may be difficult to uniformly disperse the pigment, yielding a film that has a rough surface. Illustrative examples of suitable polymers include acrylics, blends of acrylic and fluororesins, polyesters, polycarbonates, etc.

The back electrode can be formed from any suitable electrically conductive material. Illustrative examples include metals such as aluminum and magnesium that can be easily laminated by vacuum deposition. Another example is carbon paste that can be laminated as a preformed film or by coating or applying, e.g., screen-printing.

The EL device emits light when an electric current is applied to the element by connecting a power source to two terminals that are bonded to the transparent conductive layer and the back electrode. The electric current may be a direct or alternating current and typically has a voltage of between about 3 and about 200 volts, and in the case of alternating current, typically has a frequency of between about 50 and about 1000 Hertz. Illustrative direct current power sources include, dry cells, wet cells, battery cells, solar cells, etc. Alternating current can be applied through an inverter that changes the voltage or frequency of the alternating current or converts the current between direct and alternating current.

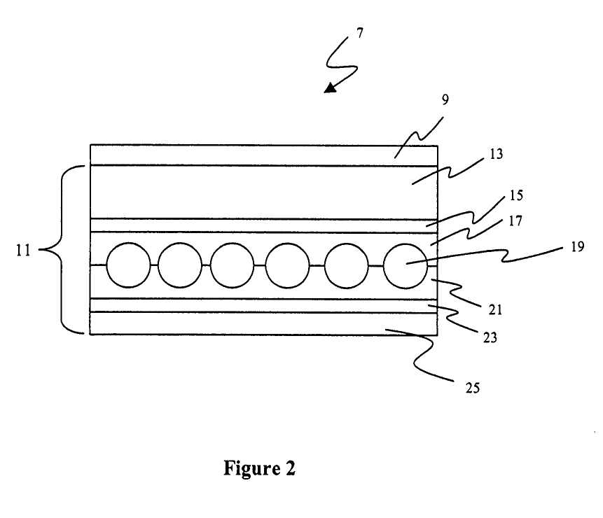

FIG. 2 illustrates a cross section of an embodiment of the invention of the indicator device 7 with a light-emissive element 11 of an electroluminescent type and a patterning layer 9 of a printed thermal dye transfer receiving layer. The layers in order from the patterning layer through the light emissive element are a patterning layer 9, a transparent substrate 13, transparent conductive layer 15, a first binder layer 17, electroluminescent particle layer 19, a second binder layer 21, an insulating layer 23, and a rear electrode 25.

In another embodiment, the light emissive element comprises organic light emitting diodes (OLED). OLEDs are preferred because they are energy efficient, can create a wide gamut of colors including white, are easy pixilated, and can be rigid or flexible.

An organic light-emitting device includes a substrate, an anode and a cathode disposed over the substrate; a luminescent layer disposed between the anode and the cathode wherein the luminescent layer includes a host and at least one dopant;

Organic light emitting diodes (OLED), also known as organic electroluminescent devices, are a class of electronic devices that emit light in response to an electrical current applied to the device. The structure of an OLED device generally includes an anode, an organic EL medium, and a cathode. The term, organic EL medium, herein refers to organic materials or layers of organic materials disposed between the anode and the cathode in the OLED device. The organic EL medium may include low molecular weight compounds, high molecular weight polymers, oligimers of low molecular weight compounds, or biomaterials, in the form of a thin film or a bulk solid. The medium can be amorphous or crystalline. Organic electroluminescent media of various structures have been described in the prior art, U.S. Pat. No. 4,769,292, reported an EL medium with a multi-layer structure of organic thin films, and demonstrated highly efficient OLED devices using such a medium. In some OLED device structures the multi-layer EL medium includes a hole transport layer adjacent to the anode, an electron transport layer adjacent to the cathode, and disposed in between these two layers, a luminescent layer. Furthermore, in some preferred device structures, the luminescent layer is constructed of a doped organic film comprising an organic material as the host and a small concentration of a fluorescent compound as the dopant. Improvements in EL efficiency and chromaticity have been obtained in these doped OLED devices by selecting an appropriate dopant-host composition. Often, the dopant, being the dominant emissive center, is selected to produce the desirable EL colors.

The indicator device preferably has a bending stiffness of between 50 and 400 milliNewtons. If the indicator device has a bending stiffness of less than 40 milliNewtons, the indicator device could bend during operation influencing the alignment between the indicator device and the detector. To correct for this, the indicator element would have to be laminated or otherwise strengthened to remain flat during operation that adds cost and complexity to the design. In one embodiment, the bending stiffness is less than 400 milliNewtons so that the indicator element can still be conformed to different shapes for timing applications. There are other applications where a stiff, rigid indicator element would be preferred.

Furthermore, the indicator device preferably has a bending radius of less than 3 centimeter. This means that the indicator device will have sufficient flexibility to be capable of being easily curled into a cylinder having a minimum radius of approximately 3 centimeters, while maintaining a smooth continuous arcuate surface without breaking like a more brittle device would.

Preferably, the light-emissive element and the patterning layer are in direct contact. This simplifies the indicator device and the manufacture of the device.

Preferably the detector is sensitive to the wavelength of light emitted by the light emissive element. This enables the detector to actually read the incoming light emitted by the indicator and helps screen out other wavelengths of light that could be caused by ambient lighting.

Preferably, the light emissive element emits light in pulses. These pulses can be timed with the detector detecting in pulses so help reduce ambient light and noise into the system. Having the light emissive element emit in pulses can also save energy by only emitting light when needed instead of being constant.

The light emissive element preferably emits light from pixels. These pixels can be illuminated or not illuminated to expose a silver halide patterning layer so create customized patterning layers and have the patterning layer aligned with the pixels. These pixels may be turned on and off to create different patterns to enable the indicator device to be used for more than one timing application.

Preferably, the light emissive element emits in more than 1 wavelength and the detector detects in more than one wavelength. By utilizing more than one wavelength more information can be detected and can provide timing redundancy for critical applications such as military aircraft or elevators, were the failure of the timing device could result in the loss of equipment or human life.

Preferably, the indicator element has more than one sensor, or detector. Preferably, the patterning layer is provided with areas without color that are adapted to be read by multiple sensors. Having multiple sensors can increase the accuracy of the device and could allow for more than one measurement at once. Preferably, the light exiting the patterning layer is detected in more than one location. For example, if the indicator was a disk, the outside area with respect to radius could measure one measurement and an inside track, read by a different detector, could be measuring a different measurement.

Preferably, the indicator device moves relative to the detector. For example, if the indicator element was a disk, the disk would be spinning and the detector would be stationary. This configuration is preferred because it is a simple setup that is most often used in the industry. In another embodiment, the detector moves relative to the indicator device. This setup can be employed when there are space constraints that do not allow the indicator element to move.

Preferably the timing device has a shield that allows the detector to only receive light from a small portion of the indicator device. This shield can be used to mask most of the indicator device so that only the detector detects a small portion of the surface of the indicator device. One embodiment of this shield could be a cone that fits onto the detector such that the small end of the cone with a little hole in it faces the sample. This limits the light coming off of the indicator element away from the area to be measured reaching the detector. This shield could also be an aperture control on the detector to shield light except for a narrow viewing angle, to have the detector only detect a small surface area of the indicator device. This shield preferably has a one degree cone to a 10 degree cone meaning the detector will only see light that enters the shield in 1 to 10 degrees off axis, depending on the cone angle selected.

The indicator element in one embodiment is provided with light focusing or shaping lenses. These lenses can be found on the detector or on or in any of the layers of the indicator device but are most preferably found on the outer surface of the patterning layer. The light shaping elements may be applied to the patterning layer before or after printing or can actually be part of the patterning layer. The light focusing structures can intensify the light emitted in the normal direction from the light-emitting surface towards the detector. This leads to more light reaching the detector and less light reaching the detector from high angles. This increased brightness results in more accuracy of the detector, or can be used to lower the light output of the light emissive element and saving energy.

These light shaping elements can be a lens array or a linear array of prismatic structures. The prismatic film is a film having a plurality of prismatic ridges that are provided in parallel with each other along one direction. The prism angle (an angle of the apex of each ridge) of the prismatic film is usually between 70 and 120 degrees, preferably between 80 and 100 degrees. When the prism angle is too small, the observation angle tends to be narrow. When the prism angle is too large, the effects for increasing the luminance may deteriorate.

The distance between apexes of adjacent prisms (prism pitch) is usually between 10 and 400 mm, preferably between 20 and 100 mm. When the prism pitch is too small, the observation angle tends to decrease. When the prism pitch is too large, the effects for increasing the luminance may deteriorate. The light directing features can be a linear array of prisms with pointed, blunted, or rounded tops.

They can also be made up of individual optical elements that can be, for example, sections of a sphere, prisms, pyramids, and cubes. The optical elements can be random or ordered, and independent or overlapping. The sides can be sloped, curved, or straight or any combination of the three.

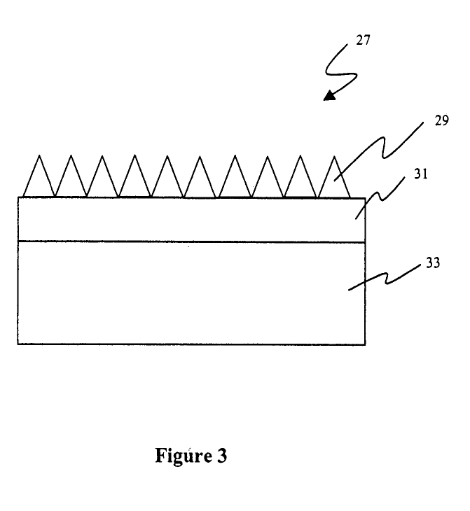

FIG. 3 illustrates this embodiment of the invention where light shaping elements are applied to the indicator element 27. A patterning layer 31 is applied to a light emissive element 33. Light shaping elements 29 are applied to the surface of the patterning layer 31 on the side opposite to the light emissive layer 33.

The indicator is preferably arcuate in shape to that it can fit to the contour of an object to be timed. For example, a rotary shaft could use an indicator element in an arcuate shape.

The indicator is preferably tubular in shape to that it can fit around the contour of an object to be timed. For example, a rotary shaft could use an indicator element in a tubular shape so that the indicator element surrounds the rotary shaft.

Preferably, the indicator element is in a tubular shape with the light-emissive element emitting light on the exterior of the tube. This facilitates the detector being inside of the tube being illuminated from the light emitting element on the outside of the tube through the pattern layer on the inside of the light emissive element. This configuration save space in a device and enables the timing device to be used in device that could not accommodate a typical prior art timing device.

A preferred encoder comprises a disk encoder. A disk encoder is radial and thus uses space very efficiently. To produce a disk encoder, the printed and processed material of the invention may be die cut to the desired shape. The die cut disk may also be laminated to a stiffening member to further improve the flatness of the material of the invention.

In another embodiment the indicator is preferably in the form of a strip. A strip indicator element is useful for positioning for movement in a linear motion. The strip encoder is produced similar to a disk encoder.

The patterning layer can be formed of any material that can be patterned. For example, thermal dye transfer, inkjet, silver halide, gravure printing, laser ablation and many other techniques can be used to form the patterning layer.

Silver halide imaging layers are preferred because they provide excellent sharpness, fine resolution of the indicator lines and can be written from a digital file. Increasing the amount of silver halide in the emulsion forms a high density black and white emulsion and as the latent image is converted to metallic silver, the density of the indicator lines increases.

A silver halide emulsion capable of forming high contrast is preferred. High contrast improves signal to noise ratio and allows for higher information density. Indicator line density is related to the log exposure range. The preferred log exposure range for the light sensitive silver halide imaging layers of the invention is between 0.51 and 0.95. This log exposure range has been shown to provide the desired contrast for common emitters and detectors utilized for timing devices.

In another preferred embodiment of the invention, the light-emissive element is provided with patterning layers on both sides of the light-emissive element. For example, application of light sensitive silver halide layers on both sides of the light-emissive element allows the material of the invention to contain indicator patterns on both sides. Double sided timing devices, which require two emitters/detectors, allow for space savings and mechanical components savings. The double-sided material can also be used to build in redundancy (substantially the same indicator pattern on both sides) into high performance systems or different indicator patterns can be used for separate control systems. In order for the indicator element to be two sided, the light emissive element must emit light on both sides. In the case of the electroluminescent light emissive element, the rear electrode can be transparent, allowing light to exit through both sides of the light emissive element. A second patterning layer is then used on top of the rear electrode for the patterning.

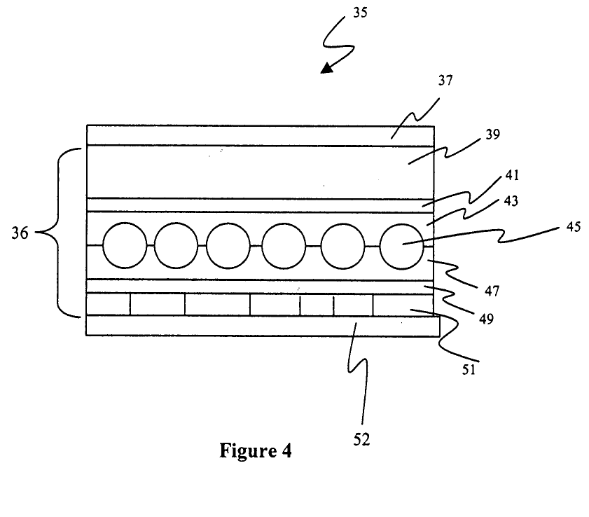

FIG. 4 illustrates this embodiment of the invention where the rear electrode is transparent and a second patterning layer 52 is applied over the transparent rear electrode 51 of the indicator element 35. The layers in order from the first patterning layer 37 to the second patterning layer 52 are a first patterning layer 37, a transparent substrate 39, transparent conductive layer 41, a first binder layer 43, electroluminescent particle layer 45, a second binder layer 47, an insulating layer 49, a transparent rear electrode 51, and a second patterning layer 52.

To improve the signal to noise ratio of the indicator element, silver halide imaging layers containing high transparency gelatin are preferred. High transparency gelatin allows source light energy to efficiently be transmitted through the density minimum areas of the indicator pattern and be reflected back through the gelatin toward the detector. A gelatin having a transparency of greater than 94% measured in a 25 micrometer layer is preferred. In order to have high transparency, pig gelatin is preferred. Pig gelatin is known to have higher transparency than typical, lower cost cow gelatin and does improve the signal to noise ratio compared to cow gelatin. Further, pig gelatin tends to have lower gel strength and thus will curl less at lower humidity further reducing signal to noise ratio of a timing device.

Preferably, a thermal printer forms the patterning layer. Thermal printing produces good image quality. The thermal dye image-receiving layer of the receiving elements of the invention may comprise polymers or mixtures of polymers that provide sufficient dye density, printing efficiency and high quality images. For example, polycarbonate, polyurethane, polyester, polyvinyl chloride, poly(styrene-co-acrylonitrile), poly(caprolactone), polylatic acid, saturated polyester resins, polyacrylate resins, poly(vinyl chloride-co-vinylidene chloride), chlorinated polypropylene, poly(vinyl chloride-co-vinyl acetate), poly(vinyl chloride-co-vinyl acetate-co-maleic anhydride), ethyl cellulose, nitrocellulose, poly(acrylic acid) esters, linseed oil-modified alkyd resins, rosin-modified alkyd resins, phenol-modified alkyd resins, phenolic resins, maleic acid resins, vinyl polymers, such as polystyrene and polyvinyltoluene or copolymer of vinyl polymers with methacrylates or acrylates, poly(tetrafluoroethylene-hexafluoropropylene), low-molecular weight polyethylene, phenol-modified pentaerythritol esters, poly(styrene-co-indene-co-acrylonitrile), poly(styrene-co-indene), poly(styrene-co-acrylonitrile), poly(styrene-co-butadiene), poly(stearyl methacrylate) blended with poly(methyl methacrylate). Among them, a mixture of a polyester resin and a vinyl chloridevinyl acetate copolymer is preferred, with the mixing ratio of the polyester resin and the vinyl chloride-vinyl acetate copolymer being preferably 50 to 200 parts by weight per 100 parts by weight of the polyester resin. By use of a mixture of a polyester resin and a vinyl chloride-vinyl acetate copolymer, light resistance of the image formed by transfer on the image-receiving layer can be improved.

The dye image-receiving layer may be present in any amount that is effective for the intended purpose. In general, good results have been obtained at a concentration of from about 1 to about 10 g/m². An overcoat layer may be further coated over the dye-receiving layer, such as described in U.S. Pat. No. 4,775,657 of Harrison et al.

Dye-donor elements that are used with the dye-receiving element of the invention conventionally comprise a support having thereon a dye containing layer. Any dye can be used in the dye-donor employed in the invention, provided it is transferable to the dye-receiving layer by the action of heat. Especially good results have been obtained with sublimable dyes. Dye donors applicable for use in the present invention are described, e.g., in U.S. Pat. Nos. 4,916,112; 4,927,803; and 5,023,228. As noted above, dye-donor elements are used to form a dye transfer image. Such a process comprises image-wise-heating a dye-donor element and transferring a dye image to a dye-receiving element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads, which can be used to transfer dye from dye-donor elements to receiving elements of the invention, are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage of the invention comprises (a) a dye-donor element, and (b) a dye-receiving element as described above, the dye-receiving element being in a superposed relationship with the dye-donor element so that the dye layer of the donor element is in contact with the dye image-receiving layer of the receiving element.

After the first dye is transferred, a second dye-donor element (or another area of the donor element with a different dye area) is then brought in register with the dye-receiving element and the process repeated. The third color is obtained in the same manner. Typical dye formulations can be found in US20030144146 (Laney et al.). A fourth patch on the donor element can be used for a protective overcoat. This overcoat may be applied pattern-wise or over the entire image or dye receiving layer. A typical protective patch can contain a mixture of poly(vinyl acetal) (0.53 g/m 2) (Sekisui KS-10), colloidal silica IPA-ST (Nissan Chemical Co.) (0.39 g/m2) and 0.09 g/m2 of divinylbenzene beads (4 μm beads) that was coated from a solvent mixture of diethylketone and isopropyl alcohol (80:20).

The patterning layer in another embodiment comprises an inkjet image. Ink jet printing is a non-impact method for producing images by the deposition of ink droplets in a pixel-by-pixel manner to an image-recording element in response to digital signals. Continuous ink jet and drop-on-demand ink jet are examples of methods that may be utilized to control the deposition of ink droplets on the DRL to yield the desired image. Ink jet printers and media have found broad applications across markets ranging from industrial labeling to optical films to desktop document and pictorial imaging.

An ink jet recording element typically comprises a support having on at least one surface thereof an ink-receiving or image-forming layer (DRL). The ink-receiving layer may be a polymer layer that swells to absorb the ink or a porous layer that imbibes the ink via capillary action.

A binder may also be employed in the image-receiving layer in the invention. In a preferred embodiment, the binder is a hydrophilic polymer. Examples of hydrophilic polymers useful in the invention include poly(vinyl alcohol), polyvinylpyrrolidone, poly(ethyl oxazoline), poly-N-vinylacetamide, non-deionized or deionized Type IV bone gelatin, acid processed ossein gelatin, pig skin gelatin, acetylated gelatin, phthalated gelatin, oxidized gelatin, chitosan, poly(alkylene oxide), sulfonated polyester, partially hydrolyzed poly(vinyl acetate-co-vinyl alcohol), poly(acrylic acid), poly(1 -vinylpyrrolidone), poly(sodium styrene sulfonate), poly(2-acrylamido-2-methane sulfonic acid), polyacrylamide or mixtures thereof. In a preferred embodiment of the invention, the binder is gelatin or poly(vinyl alcohol).

If a hydrophilic polymer is used in the image-receiving layer, it may be present in an amount of from about 0.02 to about 30 g/m², preferably from about 0.04 to about 16 g/m² of the image-receiving layer.

Latex polymer particles and/or inorganic oxide particles may also be used as the binder in the dye receiving layer (DRL) to increase the porosity of the layer and improve the dry time. Preferably the latex polymer particles and /or inorganic oxide particles are cationic or neutral. Examples of inorganic oxide particles include barium sulfate, calcium carbonate, clay, silica or alumina, or mixtures thereof. In that case, the weight % of particulate in the image receiving layer is from about 80 to about 95%, preferably from about 85 to about 90%.

The DRL used in the process of the present invention can also contain various known additives, including matting agents such as titanium dioxide, zinc oxide, silica and polymeric beads such as crosslinked poly(methyl methacrylate) or polystyrene beads for the purposes of contributing to the non-blocking characteristics and to control the smudge resistance thereof; surfactants such as non-ionic, hydrocarbon or fluorocarbon surfactants or cationic surfactants, such as quaternary ammonium salts; fluorescent dyes; pH controllers; anti-foaming agents; lubricants; preservatives; viscosity modifiers; dye-fixing agents; waterproofing agents; dispersing agents; UV-absorbing agents; mildew-proofing agents; mordants; antistatic agents, anti-oxidants, optical brighteners, and the like. A hardener may also be added to the ink-receiving layer if desired.

In order to improve the adhesion of the DRL to the light emissive element, the surface of the support may be subjected to a corona-discharge-treatment prior to applying the DRL. In addition, a subbing layer, such as a layer formed from a halogenated phenol or a partially hydrolyzed vinyl chloride-vinyl acetate copolymer can be applied to the surface of the support to increase adhesion of the DRL. If a subbing layer is used, it should have a thickness (i.e., a dry coat thickness) of less than about 2 μm.

In one embodiment, the patterning layer comprises a pattern formed by gravure printing. Gravure printing is a very quick and inexpensive way to pattern large quantities of indicator elements. Gravure print surfaces, for instance gravure cylinders, are a common means of supplying liquid compositions to webs. U.S. Pat. No. 4,373,443 describes the use of a gravure cylinder to provide ink in newspaper presses. Engraved upon the surface of the gravure cylinder are cells, which retain the liquid composition after being immersed in the reservoir. A doctor blade scrapes excess liquid composition from the surface of the gravure cylinder, such that the cylinder delivers a precise amount of liquid to a second surface upon contact. A number of distinct feed apparatus types are used to coat a gravure cylinder to produce a variety of coating flow patterns. A wide variety of solutions can be coated using gravure printing, including inks, dyes, and conductive solutions.

Preferably the patterning layer formed by conductive inks. Preferably, the inks comprise a metal. Metal inks have high reflectivity and can be patterned by such methods as laser ablation, inkjet printing, gravure printing, or thermal transfer. The adhesion of a metallic layer to paper or polymer is difficult and therefore the choice of material for adhesion is important to assure proper functionality of the final element. The metallic layer may either be chemically primed to promote adhesion or coated with a heat or pressure sensitive adhesive. The metal or metallized patterned ink layer can comprise at least one material from the following list of aluminum, nickel, steel, gold, zinc, copper, titanium, metallic alloys as well as inorganic compounds such as silicon oxides, silicon nitrides, aluminum oxides or titanium oxides. The most preferred metal layer comprises silver. Metallic silver has been shown to have over 95% reflectivity between 350 and 750 nm. Further, metallic silver has a low level of interaction with the silver halide imaging layers compared to metals that contain high amounts or iron. Finally, silver has a low oxidation rate and thus remains highly reflective over the lifetime of a typical timing. The conductive inks cannot only provide the patterning layer, but the conductive layers for the light-emitting device. Preferably the conductive ink lines have a resistivity of less than 10 ohms per square so they can efficiently conduct electricity.

In one embodiment, the transparent conducive layer in the light emissive element can be patterned forming a patterned emissive element. In the case of the electroluminescent light emissive element the patterned light emissive element pattern can be formed by patterned indium tin oxide (ITO). This patterned ITO creates a pattern that controls where on the light emissive element light emits (only the places the ITO is placed can create a circuit and therefore the places that the light emissive element would emit light). This embodiment makes the system energy efficient because light is only produced where on the indicator element necessary, instead of creating a flat field illumination and then blocking portions of it.

Furthermore, the ITO patterning layer can be created to form a passive matrix display with pixels and can be used to control the output of light at each of the pixels that the ITO forms. This enables control each one of the pixels and can be used to create changeable lighted patterns. This would be well suited to a device that changed the scale it was run at (so the line spacing could be changed) or for a timing device that could be moved to different applications as needed. The pixel pattern could be changed each time to create a specific pattern for each timing application or could even be changed continuously depending on how the timing application was run. Preferably the ITO pattern has a resistively of less than 320 ohms per square. The ITO can be deposited as a pattern or ablation techniques can be used to create the pattern.

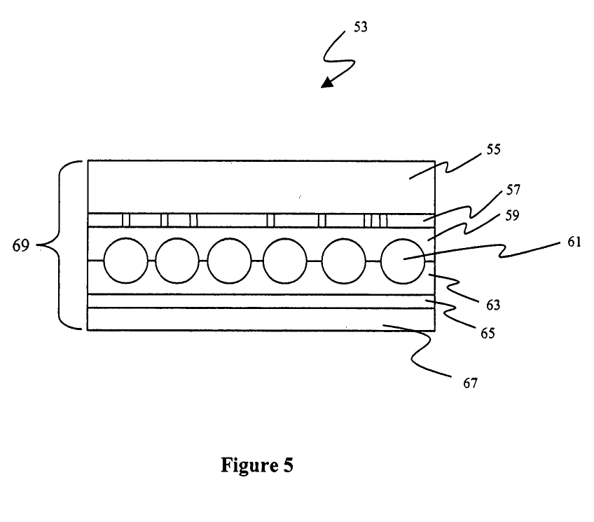

FIG. 5 illustrates this embodiment of the invention of the indicator element 53 where the transparent conductive layer is patterned and forms the patterning layer by selectively emitting light in a pattern based on the pattern in the transparent conductive layer. The layers in order from the transparent substrate to the rear electrode are a transparent substrate 55, a patterned transparent conductive layer 57, a first binder layer 59, electroluminescent particle layer 61, a second binder layer 63, an insulating layer 65, and a transparent rear electrode 67.

The patterning areas comprising a density greater than 1.8 is preferred. Densities greater than 1.8 allow for an improvement in the signal to noise ratio. Further, the higher the density, the higher the contrast between the emissive of the timing device and the high density areas of the timing device. A high contrast ratio allows for improving information density thus reducing the size of the timing device or increasing the amount of information on the timing device.

Preferably, the non-patterned areas of the patterned layer comprise colored dyes. The non-patterned areas of the patterned layer can also contain pigments and/or other colorants. Dyes and pigments are able to create a large color gamut and saturation. Furthermore, they are easily incorporated into extrusions and coatings. Nano-sized pigments can also be used; with the advantage that less of the pigment is needed to achieve the same color saturation because the pigment particles surface area to volume ratios are so large they are more efficient at adding color. For example, the colorant could be of a red coloration so that all light exiting the patterning layer is red in color. The detector can be tuned to only detect red light making the system more accurate and efficient. This also reduces the effect of ambient light on the detection system.

The indicator device has a light output preferably with an angle of view of between 1 and 50 degrees. An angle of view is defined as the degree of the normal of the film that has one half the intensity of the light at the normal to the film. More preferably, the angle of view is between 5 and 15 degrees. It has been found that this range provides light in a more collimated orientation so that more of the light reaches the detector and less is lost at large angles that so not reach the detector. With more collimated light exiting the indicator device, less light is needed to get the same signal strength as a non-collimated light source and therefore less energy is needed to get the same signal strength. This collimation can come from the light emissive element producing more collimated light, the patterning layer that can reduce the angles that are emitted from the indicator device, or collimating lens.

The light emissive element or an additional layer preferably further comprises fluorescent or phosphorescent materials. As light passes through the layer containing the florescent and phosphorescent materials, they will “glow”. The phosphorescent materials will continue to glow for a specified time after the light has removed. A typical fluorescent material is BLANCOPHOR SOL from Bayer/USA. Phosphorescent materials comprise phosphorescent pigments that are available in various colors including blue, green, yellow, orange, and red. The most common phosphorescent pigment is yellowish-green, which is brightest to the human eye, and has a wavelength of about 530 nanometers. This pigment is composed of a copper-doped zinc sulfide. A phosphorescent pigment can remain visible in the dark for up to four hours and longer, depending on the source and intensity of excitation energy, the dark adaptation of the eyes, ambient light, and area of and distance from the phosphorescence, as well as other factors. A high ultraviolet (UV) source of energy is considered most effective as an excitation source, although virtually any light is effective at stimulating phosphorescence at some level.

In providing a fluorescent or phosphorescent pigment in a form in which it can be coated or onto a substrate, the pigments are dispersed in a binding medium that must be substantially transparent and, in fact, should be of a high transparency. The particular binding medium can be selected by the skilled artisan depending on the material to be coated or in which the phosphorescent material is to be blended. Zinc Sulfide and Strontium Aluminate are two common phosphorescent materials.

The following examples illustrate the practice of this invention. They are not intended to be exhaustive of all possible variations of the invention. Parts and percentages are by weight unless otherwise indicated.

### EXAMPLES

### Example 1

In this example, an indicator element comprising an electroluminescent material as the light emitting element and thermal dye transferred image as the patterning layer.

Light Emitting Element

The light emitting element used in this example was an electroluminescent element. This electroluminescent element is composed of several layers. The electroluminescent device was created as taught by U.S. Pat. No. 6,613,455 (Matsumoto et al.). The structure of the example is shown in FIG. 2.

A PET (poly(ethylene terephthalate)) approximately 100 micrometers thick (and a light transmission of 88% at 500 nanometers) was used as the transparent substrate layer. The layer had to be transparent to let light from the electroluminescent elements out towards the patterning layer. The PET was sputter coated with indium tin oxide (ITO) at a thickness of 50 nm resulting in a surface resistivity of 250 Ω/square to create the transparent conductive layer.

The ITO surface of the transparent substrate was coated with a binder layer using a bar coater at a coating weight of 5 g/m² of a 15 percent by weight solution of a tetrafluoroethylene-hexafluoropropylenevinylidene fluoride copolymer produced by 3M; trade name “THV 200 P” having a dielectric constant of 10 (at 1 kHz) and a light transmission of 96% (polymer having a high dielectric constant) dissolved in a 1:1 mixture of ethyl acetate and methyl isobutyl ketone. This formed the first binder layer. The first binder layer layer was coated so that an exposed part of about 30 mm in width remained on each side of the ITO surface.

Applied on top of the first binder layer were phosphor particles (615A manufactured by Durel; having an average particle size of 15 to 25 μm; applied using a spray coater, and then dried at 65° C. for about 1 minute, and then at 125° C. for about 3 minutes. Thus, a laminate was formed, in which the layer of phosphor particles in the form of a substantially single particle layer (electroluminescent particle layer). The phosphor particles were embedded so that about 30% of the diameter of each particle was buried in the first binder layer. The particles were in an essentially single particle layer thickness, but were placed ramdomly. The electroluminescent layer was coated so that an exposed part of about 30 mm in width remained on each side of the ITO surface.

Next, the second binder layer was coated and dried in the same way as the first binder layer. This coating chemistry and thickness was the same as the coating for the first layer of the binder.

An insulating layer was then coated on top of the second binder layer, and dried to form an insulating layer. The composition of the coating for an insulating layer contained the above THV 200P, barium titanate, ethyl acetate and methyl isobutyl ketone in a weight ratio of 11:26:31:31. The coating was applied with a bar coater so that a coating weight after drying was 27 g/m², and dried under the same conditions as those in the case of the binder layer. The barium titanate was HPBT-1 (trade name) of FUJI TITANIUM Co., Ltd.

Finally, aluminum was vacuum deposited on the coated surface of the insulating layer through a mask to selectively deposit metal to form the rear electrode for emissive element. The vacuum deposition of aluminum was carried out under a chamber pressure of 3.0×10⁻⁴ to 5.0×10⁻⁴ Torr at a line speed of 90 m/min. Thus, a rear electrode and two busses on both edge portions, which were all made of aluminum, were formed at the same time.

To power the light-emitting element, an alternating voltage of 100 V and 400 Hz was applied between the rear electrode and busses to illuminate the EL device. The EL device uniformly emitted light over the entire luminescent surface. The voltage was supplied using a PCR 500L manufactured by Kikusui Electronic Industries, Ltd. using a sine wave of 100 V and 400 Hz.

An effective electric power P (W) and a luminance L (cd/m²) during light emitting were measured with a power meter (trade name: WT-100E manufactured by Yokogawa Electric Corp.) and a luminance meter (trade name: BM-8 manufactured by Topkon Corp.), respectively, in a dark room. The luminance of the light-emissive element was 83 cd/m² and the light emitted from the light-emissive element was green-yellow in appearance.

Patterning Layer

The patterning layer used was a thermal dye patterned layer. The patterning layer was a typical thermal dye transfer receiving layer that was printed using a thermal dye printer. The thermal dye receiving layer was coated on the transparent substrate of the electroluminescent light emitting device. The patterning layer was applied after the electroluminescent device was created, but the patterning layer could have been applied to the transparent substrate before the electroluminescent layers were applied also. The thermal dye transfer receiving layer comprised:
a) Subbing layer of Z-6020 (an aminoalkylene aminotrimethoxysilane) (Dow Corning Co.) (0.10 g/m.sup.2) from ethanol.
b) Dye receiving layer of Makrolon 5700 (a bisphenol-A polycarbonate)(Bayer AG)(1.6 g/m.sup.2), a co-polycarbonate of bisphenol-A and diethylene glycol (1.6 g/m.sup.2), diphenyl phthalate (0.32 g/m.sup.2), di-n-butyl phthalate (0.32 g/m.sup.2), and Fluorad FC-431 (fluorinated dispersant) (3M Corp.) (0.011 g/m.sup.2) from dichloromethane.
c) Dye receiver overcoat layer of a linear condensation polymer considered derived from carbonic acid, bisphenol-A, diethylene glycol, and an aminopropyl terminated o polydimethyl siloxane (49:49:2 mole ratio) (0.22 g/m.sup.2), and 510 Silicone Fluid (Dow Coming Co.)(0.16 g/m.sup.2), and Fluorad FC-431 (0.032 g/m.sup.2) from dichloromethane.

The thermal dye receiving layer was printed with a encoder pattern made up of a series of parallel black printed lines separated by non-printed areas. The design resembled a bar code with all of the lines and spacings the same width. The printing was carried out in a commercially-available Kodak XLS-8650 Printer using the Kodak Ektatherm ExtraLife® donor ribbon (details on chemistry can be found in US20030144146 (Laney et al.) The printer was equipped with a TDK Thermal Head (No. 3K0345) that had a resolution of 300 dpi and an average resistance of 3314 ohm. The printing speed was 5 ms per line. The head voltage was set at 13.6v to give a maximum printing energy of approximately 3.55 joules/cm₂ at 36.4° C. Dyes were transferred in a pattern to create the encoder pattern. The transfer of the protection layer of the donor element was transferred patter-wise to only areas that had already been printed for added protection of the pattern against scratches and wear.

The entire stack is shown in FIG. 2. The resulting indicator element worked well with a typical detector to form a timing device. The indicator element of the example had a bending stiffness of 350 milliNewtons allowing it to be stiff enough to be used as a freestanding device, but flexible enough to be adhered to a curve if needed for the timing application. The electroluminescent device in this example produced green-yellow light and the detector was tuned to detect green-yellow light, but other wavelengths of light could have been produced by different electroluminescent chemistries.

Because the indicator element is light-emitting, there is not a need for a separate light source making the example very compact allowing it to be used in applications where a prior art timing device would not be able to be used. Furthermore, because an electroluminescent light-emissive element was used instead of the traditional separate light source and the electroluminescent layer is more efficient, the example used less electricity than the prior art timing device and also created less heat.

While this example was primarily directed toward the use of light-emissive elements and patterning layers for use in timing devices, the materials of the invention have value in other diffusion applications such as back light display, signage, or security applications.

The invention has been described in detail with particular reference to certain preferred embodiments thereof, but it will be understood that variations and modifications can be effected within the spirit and scope of the invention.

Parts List

1; Indicator element
3; Patterning layer
5; Light emissive element
7; Indicator element
9; Patterning layer
11; Light emissive element
13; Transparent substrate
15; Transparent conductive layer
17; First binder layer
19; Electroluminescent particle layer
21; Second binder layer
23; Insulating layer
25; Rear electrode
27; Indicator element
29; Light shaping elements
31; Patterning layer
33; Light emissive element
35; Indicator element
36; Light emissive element
37; Patterning layer
39; Transparent substrate
41; Transparent conductive layer
43; First binder layer
45; Electroluminescent particle layer
47; Second binder layer
49; Insulating layer
51; Transparent rear electrode
52; Second patterning layer
53; Indicator element
55; Transparent substrate
57; Patterned transparent conductive layer
59; First binder layer
61; Electroluminescent particle layer
63; Second binder layer
65; Insulating layer
67; Rear electrode
69; Light emissive element

1. A timing device comprising an indicator device and a detector wherein said indicator device comprises a light-emissive element and a patterning layer.

2. The timing device of claim 1 wherein said emissive element comprises electroluminescent material.

3. The timing device of claim 1 wherein said emissive element comprises organic light-emitting diodes.

4. The timing device of claim 1 wherein said indicator device has a bending stiffness of between 50 and 400.

5. The timing device of claim 1 wherein said indicator device has a bending radius of at less than 3 centimeter.

6. The timing device of claim 1 wherein said detector is sensitive to the wavelength of light emitted by said light-emissive element.

7. The timing device of claim 1 wherein said light-emissive element emits light in pulses.

8. The timing device of claim 1 wherein said light-emissive element emits light from pixels.

9. The timing device of claim 1 wherein said light-emissive element emits light in greater than 1 wavelength and said detector is capable of sensing more than 1 wavelength.

10. The timing device of claim 1 wherein said detector comprises more than 1 sensor.

11. The timing device of claim 1 wherein said detector moves relative to said indicator device.

12. The timing device of claim 1 wherein said indicator device moves relative to said detector.

13. The timing device of claim 1 wherein said timing device is provided with a shield that only allows the detector to receive light from a small portion of said indicator device.

14. The timing device of claim 1 wherein said timing device is provided with light focusing or directing lenses.

15. The timing device of claim 1 wherein said indicator element is in an arcuate shape.

16. The timing device of claim 1 wherein said indicator element is in a tubular shape.

17. The timing device of claim 1 wherein said indicator element is in a tubular shape with the light-emissive element emitting light on the exterior of the tube.

18. The timing device of claim 1 wherein said indicator element is in a disk.

19. The timing device of claim 1 wherein said indicator element is in a strip.

20. The timing device of claim 1 wherein said patterning layer comprises a pattern formed by silver halide.

21. The timing device of claim 1 wherein said patterning layer comprises a pattern formed by a dye transfer image.

22. The timing device of claim 1 wherein said patterning layer comprises a pattern formed by ink jet printing.

23. The timing device of claim 1 wherein said patterning layer comprises a pattern formed by gravure printing.

24. The timing device of claim 1 wherein said patterning layer comprises a pattern formed by conductive inks.

25. The timing device of claim 1 wherein said patterning layer comprises a pattern formed by patterned indium tin oxide.

26. The timing device of claim 1 wherein said patterning layer comprises pattern areas of a density of at least 1.8.

27. The timing device of claim 1 wherein said patterning layer comprises non-patterned areas comprising colored dyes.

28. The timing device of claim 1 wherein said indicator device has an angle of view of between 1 and 50 degrees.

29. The timing device of claim 1 wherein said indicator device has an angle of view of between 5 and 15 degrees.
